(19) United States
(12) Patent Application Publication
(10) Pub. No.: US 2016/0145129 A1
(43) Pub. Date: May 26, 2016

(54) WATER PURIFICATION USING XYLITOL FIBRES

(71) Applicant: ROESS NATURE GROUP GMBH & CO. KG, Twistringen (DE)

(72) Inventors: Thomas Roess, Twistringen (DE); Reinhold Neisser, Schmallenberg (DE)

(21) Appl. No.: 14/892,559

(22) PCT Filed: May 23, 2014
(86) PCT No.: PCT/EP2014/060659

§ 371 Date: Jan. 19, 2016

(30) Foreign Application Priority Data
May 23, 2013 (DE) 10 2013 209 632.1

(51) Int. Cl. C02F 3/10; C02F 3/12; C02F 1/28

(52) U.S. Cl. CPC C02F 3/106; C02F 1/285; C02F 3/1263; C02F 2101/105

(57) ABSTRACT

The invention relates to a device for water purification, especially in flowing or stagnant waterbodies. In this connection, the present embodiments propose that the device has a container in which xylitol fibers are accommodated and/or that the xylitol fibers are surrounded by a structure through which it is firstly possible for water to flow and which secondly retains the xylitol fibers within the structure.

### BACKGROUND

1. Technical Field

The present embodiments relate to an apparatus and a system for water purification using xylitol fibers.

2. Description of the Related Art

As prior art, reference is firstly generally made to WO 2006/100065. This document already describes the use of xylitol fibers for various intended uses, including the use of xylitol in soil bioengineering and in environmental protection technology, for example as biofilter, natural filter, substance for pollutant reduction, etc. However, this substantially involves the use of xylitol in a very wide variety of different forms within the soil. Above all, the document discloses the formation of woven fabric, nonwoven fabric, mats, wadding bodies, fascines, shaped bodies, threads, yarns, cordage, tubular shaped bodies or the like from xylitol.

Further prior art includes: DE 10 2006 016 715 A1; DE 197 54 175 A1; Robert Frank, “Xylitwalzen zur Wasserreinigung in Teichanlagen” [Xylitol drums for water purification in ponds], Neue Landschaft, 2012, H5; pp. 442-46; DE 10 2008 022 388 A1; DE 20 2011 109 127 U1.

### BRIEF SUMMARY

With respect to the known prior art, the object is to provide for the use of xylitol for further applications and more particularly to also propose devices, by means of which the new application provides a convincing solution in the field of purification of water.

A particular aim of the embodiments is to also propose a solution which allows water purification both in flowing and in stagnant waterbodies and in wastewater treatment plants.

The embodiments propose an apparatus having the features as claimed in claim 1. Advantageous further developments are described in the dependent claims.

In the solution according to the invention, a structure is now formed which has a cavity in which xylitol fibers are accommodated. The entire structure is placed into the water for water purification and, because the structure has openings on the outside for the flow-through of water, water can easily flow through, and so the water to be purified can come into contact with the xylitol situated in the structure. The xylitol fiber, which is an ideal carrier for microorganisms, which automatically settle on the xylitol fiber, and said microorganisms arranged on the xylitol fiber are ideally suited to binding the water-dissolved pollutants, nutrients, etc., for example phosphorus, nitrate, etc., therefore purifies the polluted water. It is also possible to deliberately dope the xylitol fiber with microorganisms, i.e., so that they can colonize there, in order to further improve the purification effect.

So that the xylitol fiber does not flow out of the structure with the water, means are formed in order to retain the xylitol fiber in the structure. One means can, for example, be a type of sack in which the xylitol fiber is loosely accommodated, with the sack, however, being closed and the sack being arranged within the structure.

Instead of a sack, composed of, for example, nonwoven material, plastics material, etc., it is also possible to form a type of receptacle (e.g., gabion) from a wire, for example wire mesh or the like, which receptacle is filled with xylitol fiber and which receptacle is then closed. In this case, it is in turn possible to form a nonwoven fabric on the inner surface of the container in order to prevent fine xylitol fibers too from flowing out when water is flowing through the entire structure and thus the entire xylitol.

It is also possible to form within the structure a container, composed of, for example, plastic or the like, which container has small openings, and so water can flow through the container, and xylitol is then accommodated in the container.

It is likewise possible for the xylitol to be introduced within the structure as a shaped body, for example as shaped drum, mat, cuboid, fascine or the like, with this occurring by the xylitol fibers being shaped to give a shaped body and, by means of stitching, quilting or the like, being shaped to give the desired shaped body, and so in turn the individual xylitol fibers are retained in the shaped body when water flows through said shaped body.

The advantage of the solution according to the embodiments is that not only the individual xylitol fibers are retained within the suitability according to the invention, but that they, when the xylitol fibers are spent and/or the degradation effect of the microorganisms on the xylitol fibers abates (e.g., because the xylitol fiber can no longer sufficiently maintain its carrier function), i.e., can no longer fulfill their biological/chemical/physical function of water purification because the degradation performance of the microorganisms is exhausted.

To this end, the receptacle containing the xylitol fiber, the wire basket containing the xylitol fiber or the nonwoven sack containing the xylitol fiber or the xylitol fiber body is removed from the structure and replaced with a new one.

In particular, the embodiments are also suitable for use in a treatment plant, more particularly a treatment plant having a multichamber system. Wastewater flows through the individual chambers and, while this is happening, the microorganisms settled on the xylitol fibers can extract the pollutants and nutrients from the water to a large extent, but in any case distinctly reduce the content of pollutants and nutrients in the water. The embodiments are likewise suitable for the xylitol fiber having the described structure forming an exhaust air filter, through which malodorous exhaust air can then flow, for example in rendering plants, oil mills or the like, so that it is thus possible to purify the exhaust air or to release it from the foul odor.

The embodiments will now be more particularly elucidated on the basis of an exemplary embodiment.

### BRIEF DESCRIPTION OF THE SEVERAL VIEWS OF THE DRAWINGS

FIG. 1 shows a solution according to the embodiments in a pond,

FIG. 2 shows a solution according to the embodiments on a flowing waterbody, for example a stream, river or the like,

FIG. 3 shows the principle of a solution according to the embodiments in a treatment plant.

### DETAILED DESCRIPTION

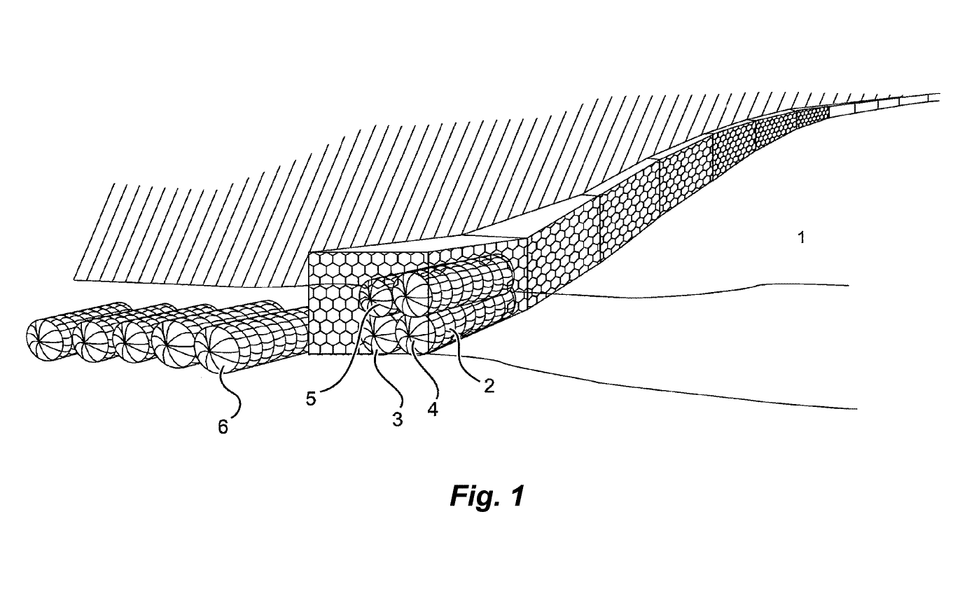

FIG. 1 shows the top view of a section of a pond 1. Especially ponds lying in agricultural areas are regularly overloaded by the input of nutrients, particularly of phosphate, nitrates, etc., frequently to such a great extent with said nutrients that they have a tendency to form algae very strongly and can completely “die” as a consequence of “overfertilization”.

According to the invention, it can be seen that, in the pond 1, gabions 2 are formed on one side, which gabions form an all-around wire structure 3 on the outside, it preferably being possible for the wire structure to be opened or closed on one side for filling or removing the xylitol drums 4 formed within the gabions.

The xylitol drums 4 are tubular (sausage-like) bodies which, for example, can have a net structure 5 on the outside and are filled with xylitol fibers in the interior and which are enveloped by a fine woven fabric, wire or the like, particularly on their exterior, in order to prevent the individual xylitol fibers from leaving the tubular structure upon flow-through of water, ensuring reliable protection that the xylitol fibers remain within the drum body upon flow-through of water, but at the same time can also allow water to easily flow through.

In FIG. 1, it can be seen that multiple gabions 2 are positioned behind one another, and so very many drum bodies can be reliably accommodated in the pond, and the accommodation of the gabions also reliably prevents the entire gabion body containing the drums from being able to float to the water surface.

If, after a certain time, the degradation performance of the microorganisms (which have settled on the xylitol fibers of the xylitol drums, etc.) has abated to such an extent that no more appreciable reduction of pollutant and/or nutrient contents is to be expected, the xylitol drums can be exchanged with relative ease, by either removing the individual drums 6 from the water or removing the individual drums 4 from the gabion 2 or removing entire gabions 2 containing the drums 4 from the water.

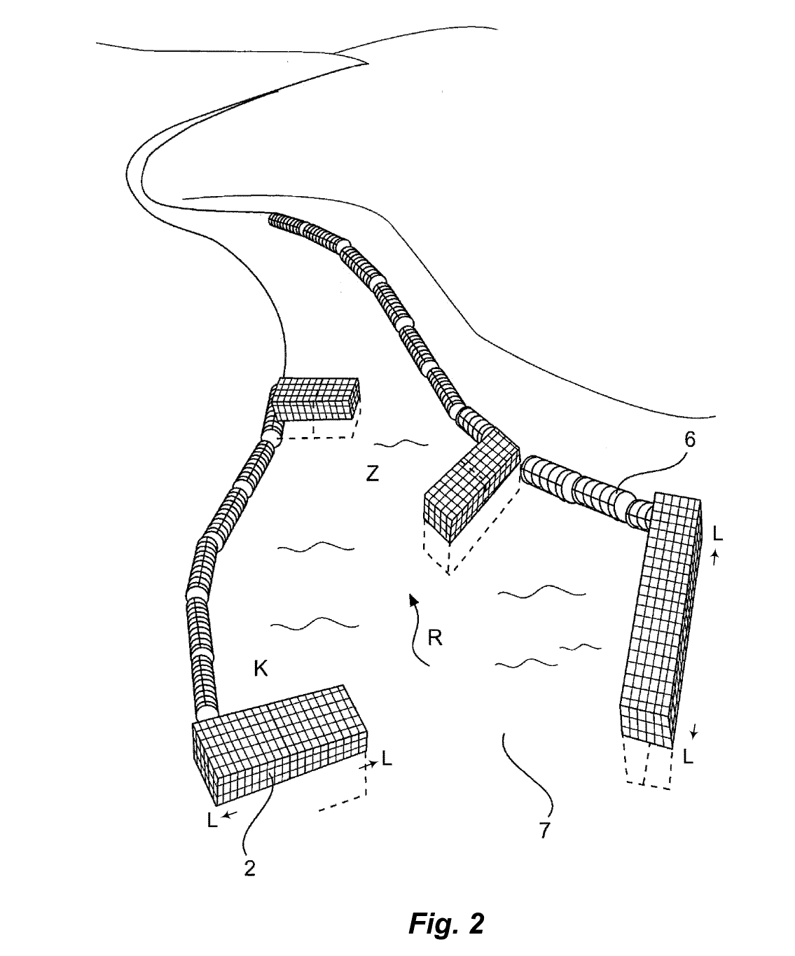

A solution similar to the previously presented solution is shown in FIG. 2, though for a flowing waterbody 7.

It can be seen therein that the drum bodies 6 lie partly in the water and also partly protrude from the water. The same applies to the gabions 2 shown therein, which, in the example presented, are submerged to an extent of about ⅔ in the water (as in FIG. 1) and protrude from the water to an extent of about ⅓.

The advantage of this formation in particular is that additionally, within the river bed, there is also the possibility for animals to settle on the drum bodies or on the gabions. However, at the same time, water easily flows through the entire xylitol material and said material can thus actively make a contribution to cleaning the water.

What is achieved by the formation of gabions 2, which have a particular longitudinal direction L-L and are thus arranged transversely to the flow direction R, as in the example shown, is that the flow pattern is also altered in the desired manner and thus calm zones (potholes) K and rapidly flowing zones Z are formed and thus water mixing is increased overall and, as a result, the purification effect due to the individual xylitol drums 6 or gabions 2, in which the xylitol drums 4 are situated, is improved in turn.

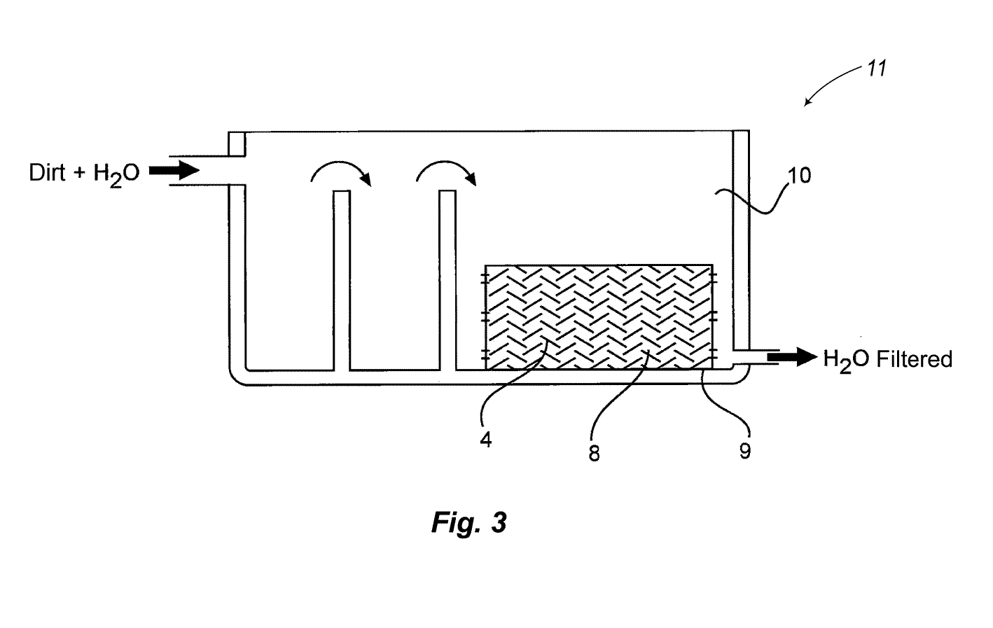

FIG. 3 shows the example of a 3-chamber treatment plant system 11, the xylitol fibers 8 being accommodated within a shaped structure 9 only in the third chamber 10. There too, these xylitol bodies 4 or container containing xylitol are in turn subjected to the flow-through of wastewater and the water can thus be purified by the activity of the microorganisms. It is also possible to fill the xylitol fibers loosely into the chamber, but care must then be taken that the xylitol fibers remain in the chamber with the movement of the water. This can be ensured, for example, by a container which is placed into the chamber and through which the water can flow, but which has, particularly on the outlet side, filters which prevent the xylitol fiber from flowing out of the container and thus out of the chamber. In one embodiment, the structure 9 holding xylitol fibers 8 is abutting the wall of the third chamber 10 and covering the outlet for the filtered water and thus requiring that all water must pass through the structure 9 in order to exit the plant system 11.

In all the aforementioned cases, formation of an appropriate structure 9 for the xylitol fibers prevents xylitol fibers from being transported away with the flow. Said structure 9 can take many different forms, for example by the formation of a basket, container, sack or the like composed of nonwoven material or else wire material, plastics mesh or plastics lattice (but in this case very closely meshed), in the interior of which the xylitol is accommodated, and wherein said sack is then closed and is placed into the gabion or into the chamber.

The particular advantage of this is that a very simple exchange of the old, spent xylitol material for new, unspent xylitol material is possible, by the sack containing the spent xylitol material being removed and being replaced with a new one containing fresh xylitol material. Loosely filled xylitol can be removed from the container accommodating the xylitol fiber material by means of a suction device, as well.

However, it is also possible to open the sack or any receptacle that forms the structure 9 to remove the spent xylitol material and to replace it with new material, and to subsequently place the sack back again into the chamber 10, the gabion, or the plant system 11.

Instead of the drums 4, 6 that have been described and shown, it is also possible for cuboids or mattresses or the like to be formed from the xylitol material (e.g., by stitching, quilting and the like), and so these structures reliably retain the individual xylitol fibers. Said mattresses are then placed horizontally into the waterbody or, according to the invention, they are rolled up to give a roll and then fixed as a roll and thus placed into the waterbody.

But as also shown, such mattresses in planar form or else rolled-up can be placed into a container closed on all sides, such as, for example, a gabion, a river mattress, a concrete container, a plastics container, a steel container or the like, it only needing to be ensured that the water can easily flow through the container.

As likewise shown, the xylitol fibers can be accommodated in drum-shaped structures composed of a mesh structure porous on all sides, so-called “sink drums” or “sack gabions”, which are then lowered into the waterbody.

It is also possible and advantageous to introduce, in addition to the xylitol material, other material, such as, for example, slag, which additionally permanently supports the reduction of phosphate. Furthermore, it is also possible to additionally include natural fiber material, for example coconut fiber, wood fiber or the like, in order, for example, to support a (short-term) purification effect (said purification effect abates when the coconut fiber, wood fiber, etc., rot and are thus no longer a base for the settled microorganisms).

Furthermore, it is likewise possible to additionally add weights, for example stone material or slag, to the containers in addition to the xylitol fibers, and this, firstly, leads to weighing-down of the entire structure and thus counters an undesired flotation of the structure and, secondly, also provides further cavities between the stones, between which it is firstly possible for the fibers to get stuck and be retained, and it is in turn secondly possible for organisms to settle specifically in such cavities, which organisms further improve the overall purification process. As a result of the intensive colonization of xylitol fibers, it is thus possible for regions of biological activity to arise within the waterbody. Since the xylitol fiber has a high resistance to rotting, it can ensure its effect over some time, possibly even for decades.

The embodiments can thus be summarized as follows: there is provided a xylitol fiber volume, it being ensured that the individual xylitol fibers are retained within the volume. This can be achieved by forming a shaped body by means of the xylitol fiber itself into a sack, such as by stitching, quilting, drawn-loop knitting, formed-loop knitting, weaving, braiding, etc., or by accommodating the xylitol fiber within a sack-like receptacle that holds the fibers inside its interior or equally accommodating it in a cube-shaped or cylindrical container having sufficient openings allowing flow-through, it being ensured however that the xylitol fibers are retained within the container, for example by fine filters in front of the openings of the container.

Furthermore, it is ensured that the xylitol fiber body or the receptacle containing xylitol fiber can be easily exchanged, and so spent xylitol material filled with the dirt that has been filtered can be replaced in a simple, convenient and rapid manner with new, clean, unspent xylitol material.

At the same time, on an individual basis, it is possible by packing of the xylitol material to not only accommodate more xylitol material within a particular volume, but also to determine the flow velocity.

Where the use of xylitol fiber material is mentioned in the present invention, what is especially meant is xylitol fiber material in which the majority of it has a fineness within the range of 100 to 1000 tex (measured in accordance with ISO 11 44 or DIN 60905).

This means that at least 50% of the xylitol fiber material used has the specified degree of fineness, which is approximately within the range of 100 to 1000 tex. In one embodiment, over 70% of the material has this range of fineness, and preferably more than 80% to 90% has this degree of fineness.

Lastly, the embodiments also propose a solution that the xylitol fiber according to the embodiments—also completely independently of the presently described solution—is used for being accommodated in a pressure vessel in which pipes which have radial openings and which are jacketed by xylitol fiber material are installed. A further good example of this is also the jacketing of drainage pipes by xylitol fibers. In this case, the xylitol fiber and coconut fibers, textile scraps, textile fibers, etc., is attached to drainage pipes, for example by a cross-winding of a yarn material, preferably composed of plastic or the like. It is known that, for the drainage of surfaces, the drainage pipes discharge the surface water specifically into subjacent trenches. Since the drainage pipes jacketed by xylitol are now installed in the soil, the microorganisms also settle thereon, which microorganisms are specialized in degrading nutrients such as, for example, phosphates, nitrates, etc., or pollutants which are situated in the water to be drained. The microorganisms accumulate said nutrients and “consume” said nutrients for their own growth, and so said nutrients are no longer contained in the water flowing through the drainage pipe.

The present embodiments also encompass the variant comprising a device for water purification, especially flowing or stagnant waterbodies, wherein the device is a stone mattress net, i.e., is a netting, preferably a large-meshed net which forms a container into which stones are filled and the net forms not only the container for the stones, but also for the xylitol fibers which are accommodated in the stone mattress net, for example are also stuck between the stones forming a structure. This structure can therefore be a gabion that is formed of a stone mattress net.

In the case of such a variant according to the invention, the xylitol fibers introduced into the stone mattress fill out especially the cavities which arise between the natural stones owing to the irregular shape and structure thereof.

The stones can be natural stones or else stones from a quarry, i.e., especially stone material having an irregular outer surface and having an irregular diameter and size. A stone mattress or a stone mattress net, from which the present embodiments proceed, is known from DE 20 2011 109 127, the content of which is incorporated by reference into the present application. The stone mattress net disclosed therein is used especially for fortifying banks of courses of rivers, stagnant waterbodies, canals or the like. Now, the stone mattress according to the embodiments, or the stone mattress net according to the embodiments, is not only filled with stones as in DE-U-20 2011 109 127, but xylitol fiber material is additionally concomitantly introduced into the stone mattress, i.e., into the stone mattress net, and said xylitol fiber material is also retained within the mattress net by the stone composite.

Thus, the stone mattress net according to the embodiments can be used not only for bank fortification, but can also simultaneously contribute to water purification, when the water in the waterbody in which or on which the stone mattress net lies also completely or partly washes around the stone mattress net.

Instead of loosely introducing the xylitol fiber into the stone mattress net, it is likewise possible for xylitol fiber drums or other xylitol fiber structures or xylitol fiber bodies (e.g., including xylitol fiber-filled sacks, xylitol fiber cuboids, xylitol fiber cylinders, xylitol fiber mats) to be included in the stone mattress net, and so the xylitol fiber material can be easily retained in the stone mattress net when water flows through.

In the present disclosure, the following reference numbers are used for the listed structures.
1 Pond
2 Gabions
3 Wire structure
4 Xylitol drums
5 Net structure
6 Drum body full of xylitol
7 Flowing waterbody
8 Xylitol fibers
9 Shaped structure
10 Third chamber
L-L Longitudinal direction
R Flow direction
K Pothole (calm zones)
Z Flowing zones

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for water purification in flowing or stagnant waterbodies, comprising:
a container in which xylitol fibers are positioned; and
a structure which surrounds the xylitol fibers, the structure permitting water to flow therethrough and also retaining the xylitol fibers within the structure.

2. The device as claimed in claim 1,
wherein the structure is composed of at least one of a nonwoven fabric, woven fabric, loop-drawingly knitted fabric, loop-formingly knitted fabric, and a lattice or the like, which forms a sack having an interior cavity, the xylitol fibers being held within the interior cavity and being in contact with the interior walls of the sack,
wherein the sack is a closed body.

3. The device as claimed in claim 1,
wherein the structure is a rigid body which has an interior cavity for accommodating the xylitol fiber.

4. The device as claimed in claim 1,
wherein the structure is a container which has openings for the flow-through of water and in the interior of which means are formed in order to retain the xylitol fiber.

5. The device as claimed in claim 1,
wherein the xylitol fibers are shaped to form a body by weaving, quilting, stitching or the like of the fibers, and that the body is accommodated in the structure.

6. The device as claimed in claim 1,
wherein the structure allows a removal of the xylitol fiber and a reinsertion of new xylitol fiber.

7. The device as claimed in claim 1,
wherein the structure is a gabion which accommodates in its interior xylitol fibers, which accommodates therein in a receptacle composed of at least one of nonwoven material, wire material or the like or xylitol fibers shaped to form a body,
wherein the gabion is closed on all sides, but can be opened on the top side for replacement of the xylitol fiber material.

8. A device for water purification, comprising:
a closed container which is used for purifying wastewater in accordance with a sequencing batch reactor method,
wherein the container has at least two or more chambers,
xylitol fibers accommodated in at least one chamber and means are provided which prevent the xylitol fibers from being removed from the chamber as a result of liquid flowing through the chambers and the xylitol fibers are surrounded by a structure which retains the xylitol fibers within the structure.

9. The device as claimed in claim 8,
wherein the means which prevent surfacing of the xylitol fibers at the water surface are formed in the structure.

10. The device as claimed in claim 9,
wherein a weight agent for holding down the xylitol fiber is formed in the structure.

11. The device as claimed in claim 9,
wherein the receptacle which accommodates the xylitol fibers is attached to the structure in order to prevent flotation of both the xylitol fiber or any receptacle that contains the xylitol fiber.

12. The device as claimed in claim 8,
wherein the xylitol fibers are accommodated in a container which is closed on all sides and that the entire container interior is closed up with a lid on the top side and the xylitol fills out the entire cavity.

13. The device as claimed in claim 8,
wherein the xylitol fiber has a fineness within the range of approximately 100 to 1000 tex.

14. The device as claimed in claim 13,
wherein more than 50% of the xylitol fiber used has a fineness which is approximately within the range of 100 to 1000 tex.

15. The device as claimed in claim 8,
wherein the device is a stone mattress net that is a structure which is filled with stones, and that the xylitol fiber is accommodated in the stone mattress and the xylitol fiber is retained in the mattress net by the stones.

16. The device according to claim 8,
wherein more than 80% but less than 90% of the fiber used has a fineness which is approximately within the range of 100 to 1000 tex.
